(19) United States
(12) Patent Application Publication
(10) Pub. No.: US 2013/0284488 A1
(43) Pub. Date: Oct. 31, 2013

(54) STRANDED ELECTRICAL INSULATED WIRE CONDUCTOR

(71) Applicant: Shirou Yabuki, Susono-shi (JP)

(72) Inventor: Shirou Yabuki, Susono-shi (JP)

(73) Assignee: YAZAKI CORPORATION, Tokyo (JP)

(21) Appl. No.: 13/989,945

(22) PCT Filed: Nov. 21, 2011
(86) PCT No.: PCT/JP2011/077289

§ 371 Date: Jul. 17, 2013

(30) Foreign Application Priority Data
Nov. 29, 2010 (JP) 2010-265021

(51) Int. Cl. H01B 7/00

(52) U.S. Cl. CPC H01B 7/00
USPC 174/110 R

(57) ABSTRACT

The present invention provides a stranded electrical insulated wire conductor which includes a center element wire, an inner layer having a plurality of element wires arranged around the center element wire, and an outer layer having a plurality of element wires arranged around the inner layer. The inner layer has at least seven second element wires which have the same diameter as that of the center element wire or are smaller than the diameter thereof. The second element wires of the inner layer are respectively contacted with the center element wire, and the adjacent second element wires of the inner layer are contacted to each other. The cross-section of the stranded electrical insulated wire conductor is formed in a circle without worsening flexing characteristics.

### TECHNICAL FIELD

The present invention relates to a stranded electrical insulated wire conductor.

### BACKGROUND ART

A stranded electrical insulated wire conductor is generally formed by stranding with seven, or nineteen core wires of the same diameter. Therefore, a cross-section of the whole conductor is a hexagonal shape (show a model cross-sectional diagram of covered electric wire having a conductor formed with nineteen core wires 11 in FIG. 4). However, against the conductor of such hexagonal cross-section, an outer circumference shape of a covering layer 12 is preferable to be in a complete round shape so that wiring is easily performed and quality property is stabilized. For this reason, in the covering layer, a part of wall thickness except a necessary part (a hatching part shown in FIG. 4) in order to obtain permanent insulation performance is formed. As a result, the weight of the electrical insulated wire is increased. Thereby, it is difficult to reduce the weight of an electrical wire for vehicle. Furthermore, cost is increased since a lot of insulating material is used in the covering layer.

In order to improve such defect, in patent document 1, as shown in FIG. 5, technique that a cross-section of a stranded wire conductor is formed in a round shape by using wires of three different types is disclosed. More specifically, seven center element wires 13, wires (thick diameter wire 14) thicker than the center element wire 13, and wires (thin diameter wire 15) thinner than the center element wire 13 are used in the patent document 1.

However, in the above technique, since the thick diameter 14 thicker than the center element wire 13 is arranged in an outside layer, there is a problem that flexing characteristics is reduced when the stranded wire conductor is arranged on a bent portion in electrical wires for the vehicle.

### CITATION LIST

[Patent document 1]: Japanese patent Application Publication No. 2007-317477

### SUMMARY OF THE INVENTION

Accordingly, an object of the present invention is a stranded electrical insulated wire conductor in which conventional problem described above is improved, flexing characteristics is prevented from worsening, and the cross-section shape thereof is formed with an approximately circular shape.

In order to achieve the above-mentioned objects, a stranded electrical insulated wire conductor includes a center element wire, an inner layer having a plurality of element wires arranged around the center element wire, an outer layer having a plurality of element wires arranged around the inner layer. The inner layer has at least seven second element wires which have the same diameter as that of the center element wire or are smaller than the diameter thereof. Further, the second element wires of the inner layer are respectively contacted with the center element wire, and the adjacent second element wires of the inner layer are contacted to each other.

Furthermore, in the stranded electrical insulated wire conductor of the present invention, second element wires which are the same number of the second element wires of the inner layer are arranged in the outer layer. The second element wires of the outer layer are arranged in contact with the adjacent two second element wires of the inner layer, respectively.

### EFFECT OF THE INVENTION

Furthermore, in the stranded electrical insulated wire conductor of the present invention, a third element wire which is contacted with a circle circumscribed to all the second element wires of the inner layer and a circle circumscribed to all the second element wires of the outer layer is arranged between the adjacent two second element wires of the outer layer.

Furthermore, in the stranded electrical insulated wire conductor of the present invention, the element wires of the inner layer and the element wires of the outer layer are twisted in the same direction.

Furthermore, in the stranded electrical insulated wire conductor of the present invention, both the second element wires and the third element wires are smaller than the center element wire.

Furthermore, in the stranded electrical insulated wire conductor of the present invention, both the number of the second element wires of the outer layer and the number of the third element wires of the outer layer are equal to the number of the second element wires of the inner layer.

Furthermore, in the stranded wire conductor for the electrical insulated wire of the present invention, the sum of the cross-sectional areas of the second element wires arranged in the outer layer and the third element wires arranged in the outer layer is equal to or greater than 50% of the total cross-sectional area of the stranded wire conductor for the electrical insulated wire.

EFFECTS OF THE INVENTION According to the stranded electrical insulated wire conductor of the present invention, the stranded electrical insulated wire conductor having the nearly circular shape in the cross-section can be provided without worsening flexing characteristics. Therefore, an electrical insulated wire which is uniform in insulated layer thickness, economical and lightweight can be provided. Further, an electrical wire having a small diameter against capacity can be provided. Furthermore, an electrical wire suitable for use in vehicle electric field can be provided.

Furthermore, according to the present invention, an outer diameter of the stranded electrical insulated wire conductor can be minimized as possible. Furthermore, loss of shape in the stranded electrical insulated wire conductor can be prevented.

Furthermore, according to the present invention, the space between the element wires can be reduced while maintaining the total cross-section in a circle. Thereby, the non-uniform thickness of insulated layer can be reduced. Furthermore, an electric insulated wire having a small diameter compared with the capacity can be provided.

Furthermore, according to the present invention, contact of each wire is stabilized. Furthermore, since the space between the element wires is reduced, a maximum outer diameter can be reduced as possible. Furthermore, products of stable shape can be produced.

Furthermore, according to the present invention, the stranded electrical insulated wire conductor having excellent flex resistance can be provided.

Furthermore, according to the present invention, the element wire can be inserted into space inescapably generated between the element wires of the inner layer. Therefore, the capacity can be effectively increased or the outer diameter can be small.

Furthermore, according to the present invention, the number of element wires in contact with a crimping terminal is increased. Therefore, connection reliability improves.

In the other words, the point for reducing contact resistance is so as to pass an electric current smoothly. If the number of element wires contacted with the crimping terminal is increased, flow of electricity passes smoothly. However, in the conventional art, when the number of the element wires is increased so as to improve bend performance, the number of the element wires arranged in the outermost layer decreases. In contrast, according to the stranded electrical insulated wire conductor of the present invention, even if the number of the element wires which are contacted with the crimping terminal is increased, bend performance can be improved.

### BRIEF DESCRIPTION OF THE DRAWINGS

FIG. 1 is a model diagram showing a cross-section surface of a stranded electrical insulated wire conductor A according to the present invention;

FIG. 2 is an explanatory diagram in order to explain a diameter of each element wire and arrangement thereof in the stranded electrical insulated wire conductor A;

FIG. 3 is a model diagram showing an example of another stranded electrical insulated wire conductor according to the present invention;

FIG. 4 is a model diagram showing an example of an electrical insulated wire according to conventional technology; and

FIG. 5 is a model diagram showing an example of a stranded electrical insulated wire conductor according to conventional technology.

### DESCRIPTION OF TBE PREFERRED EMBODIMENT

A stranded electrical insulated wire conductor of the present invention includes three types of a center element wire, a second element wire thinner than the center element wire, and a third element wire thinner than the second element wire. Around the center element wire, at least seven second element wires are arranged, and an inner layer is formed with the second element wires. More specifically, the inner layer is contacted with the center element wire, and is constructed by connecting the second element wire with the adjacent second element wire. Around the inner layer, an outer layer is formed with the second element wire and the third element wire. The second element wire and the third element wire in the outer layer are interlaminated. The second element wire of the outer layer is contacted with the two adjacent second element wires of the inner layer, and is arranged therewith. Furthermore, the third element wire of the outer layer is contacted with a circle circumscribed to all the second element wires of the inner layer and a circle circumscribed to all the second element wires of the outer layer, and arranged in the outer layer.

Hereafter, embodiments of a stranded electrical insulated wire conductor in the present invention will be explained with reference to the drawings.

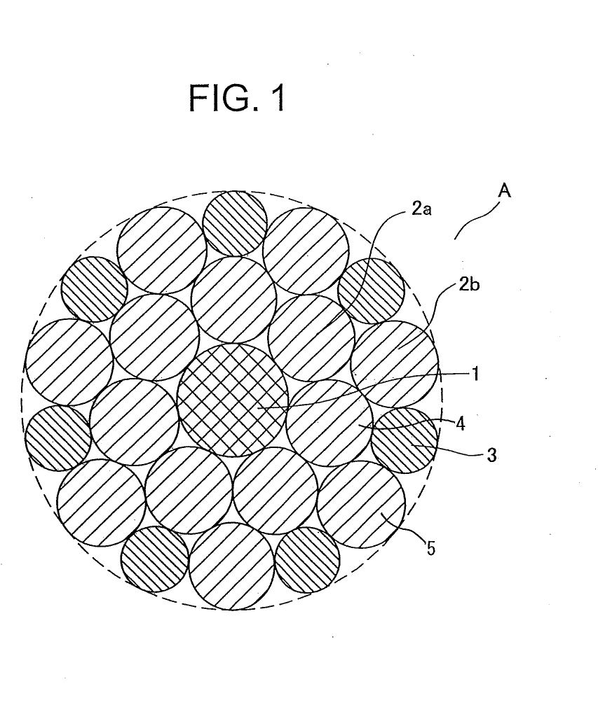

FIG. 1 is a cross-section diagram showing the stranded electrical insulated wire conductor A (Hereafter, stranded wire conductor A) according to the present invention in the first embodiment. In the center, a center element wire 1 is arranged. Around the center element wire 1, seven second element wires 2a are arranged, and an inner layer 4 is formed with the second element wires 2a. Each second element wire 2a of inner layer 4 is contacted with the center element wire 1, and the second element wires 2a adjacent to each other are contacted.

Around the inner layer 4 formed with seven second element wires 2a, an outer layer 5 is formed by alternately arranging a second element wire 2b (equal to the second element wire 2a arranged in the inner layer 4) and a third element wire 3.

The second element wire 2b of the outer layer 5 is contacted with the second element wire 2a located adjacent to each other in the inner layer 4. By this configuration, the second element wire 2b of the outer layer 5 is equal to the number of the second element wire 2a of the inner layer 4. In this embodiment, the number is seven, that is, seven second element wires 2a of the inner layer 4 and seven second element wires 2b of the outer layer 5 are arranged.

In both sides of the second element wire 2b in the outer layer 5, the third element wire 3 is arranged. Furthermore, the third element wire 3 is contacted with the second element wire 2a of the inner layer 4. The outer layer 5 is contacted with a circle circumscribed to all the second element wires 2a of the inner layer 4 and a circle circumscribed to all the second element wires 2b of the outer layer 5.

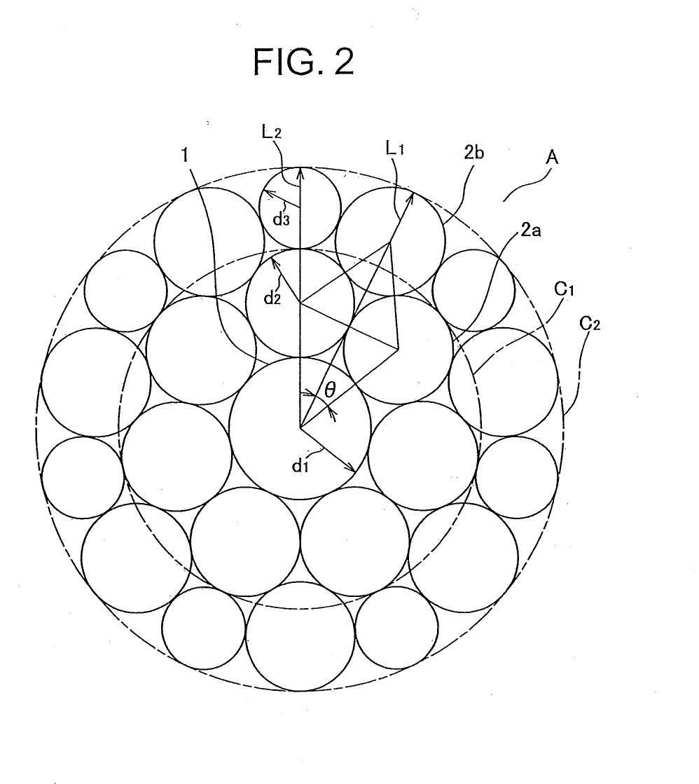

Furthermore, the third element wire 3 of the outer layer 5 is contacted with a circle C1 (shown in FIG. 2) circumscribed to all the second element wires 2a of the inner layer 4 and a circle C2 (shown in FIG. 2) circumscribed to all the second element wires 2b of the outer layer 5, and arranged.

When the wires are arranged as described above, the following formula (1), in which d₁ is a radius of the center element wire 1; d₂ is a radius of the second element wire 2a; d₃ is a radius of the third element wire 3; n is the number of the second element wire 2a in the inner layer 4; and θ=180°/n, is implemented.

[Formula 1]

d₂=(d1+d₂) sin θ (1)

In the formula (1), when n: the number of the second element wire 2a is 7, and a diameter (2d₁) of the center element wire 1 is 0.37 mm, each diameter (2d₂) of the second element wires 2a and 2b is 0.284 mm.

Furthermore, a radius L1 of the circle C2 circumscribed to all the second element wires 2b of the outer layer 5 is calculated by the following formula (2).

[Formula 2]

L1=(d₁+d₂) cos θ+2d₂ sin 60°+d₂ (2)

Meanwhile, the radius L1 is equal to a radius L2 of a circle circumscribed to all the third element wires 3 of the outer layer 5. Namely, the radius L1 is equal to d₁+2d₂+2d₂. Thereby, the following formula (3) is implemented, and a diameter (2d₃) of the third element wire is 0.213 mm.

[Formula 3]

2d₃=(d₁+d₂) cos θ+2d₂ sin 60°+d₂−d₁−2d₂ (3)

Additionally, at this time, a diameter 2L1 (=2L2) of the stranded electrical insulated wire conductor is 1.36 mm, the total cross-sectional area is 1.24 mm², and a cross-sectional area of the outer layer 5, that is, the sum of the cross-sectional areas of the second element wire 2b and the third element wire 3 in the outer layer 5, is 0.691 mm², and is 55.7% of the total cross-sectional area of the stranded wire conductor A.

By the above construction, in the wires constructing the stranded wire conductor A, a thick wire, which is thicker than the center element wire 1, is not provided in the inner layer and the outer layer. In addition, the thick wire thicker than the wire of the inner layer is provided in the outer layer. Therefore, flexing characteristics can be prevented from being reduced. Furthermore, the stranded wire conductor in which the cross-section is approximately-circular shape can be provided. Thereby, when an insulated layer is provided, an electrical insulated wire which is uniform, economical and lightweight can be uniformity provided. Furthermore, the insulated wire for preferred using in vehicle electric field can be provided. Additionally, in such stranded wire conductor, by twisting the inner layer and the outer layer in the same direction, each wire is surely contacted each other and arranged. Thereby, contact of each element wire is stabilized. Furthermore, since the space between the element wires is reduced, a maximum outer diameter can be reduced as much as possible. Furthermore, since the stable shape is formed, products of stable shape can be produced.

Additionally, in this embodiment, since the sum of the cross-sectional area of the second element wire 2b and the third element wire 3, in which they constitute the outer layer, is 55.7% of the total cross-sectional area of the stranded wire conductor, electric contact with a crimping terminal is good.

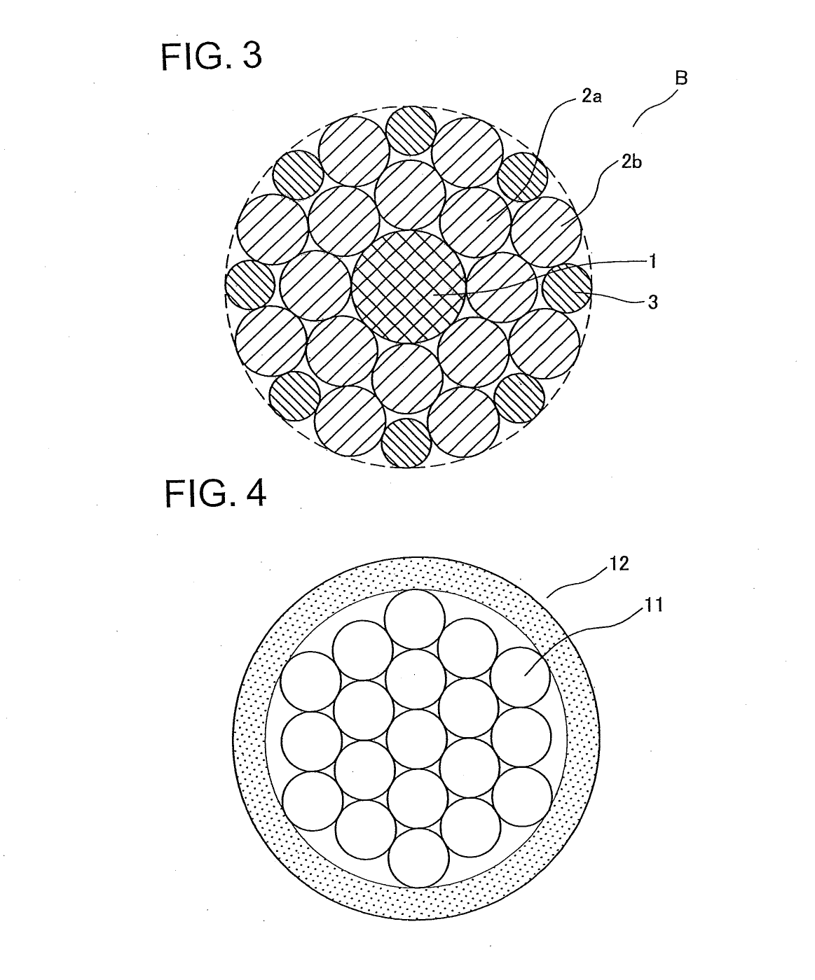

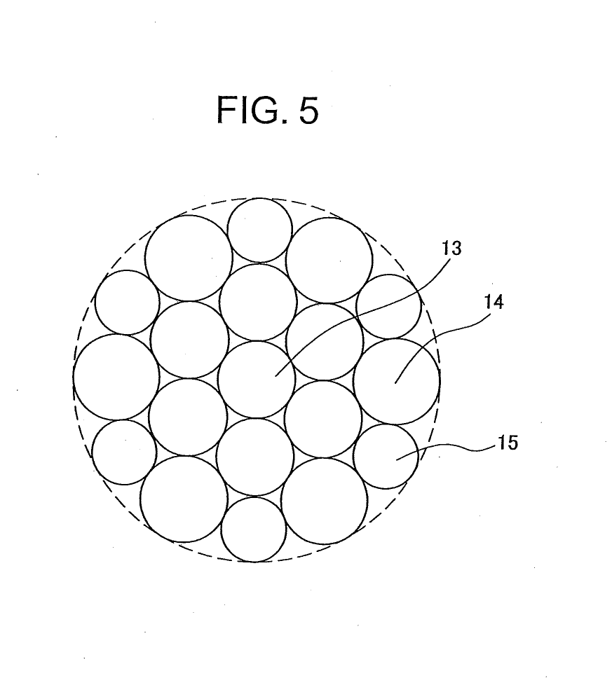

In the above, example that seven the second element wires are arranged in the inner layer 4 is shown. In FIG. 3, second embodiment that a stranded electrical insulated wire conductor B (Hereafter, stranded wire conductor B) including eight the second element wires in the inner layer is shown.

At this time, when a diameter of the center element wire 1 is 0.37 mm, a diameter of the second element wire is 0.229 mm, a diameter of the third element wire is 0.175 mm, a diameter of circumscribed circle is 1.18 mm, the total cross-sectional area is 0.856 mm², and the cross-sectional area of the outer layer is 0.459 mm². Therefore, the sum of the cross-sectional areas of the second element wire 2b arranged in the outer layer and the third element wire 3 is 53.6% of the total cross-sectional area of the stranded wire conductor B.

An annealed copper wire is generally as a wire constructing the stranded electrical insulated wire conductor of the present invention. A wire constructed with a tinned annealed copper wire, a pure aluminum or an aluminum alloy may be used with a conductor.

Furthermore, the stranded electrical insulated wire conductor of the present invention can arrange an insulated layer at the periphery thereof by extrusion molding as well as a conventional stranded wire conductor.

It should be noted that the embodiment has only been illustrated as a typical one of the present invention, and the present invention is in no way limited to the illustrated embodiment. Hence, the present invention can be effectuated with various modifications made thereto within the scope of the present invention.

### REFERENCE SIGNS

1 Center element wire
2a Second element wire (inner layer)
2b Second element wire (outer layer)
3 Third element wire
A, B stranded electrical insulated wire conductor

1. A stranded electrical insulated wire conductor comprising:
a center element wire;
an inner layer having a plurality of element wires arranged around the center element wire; and
an outer layer having a plurality of element wires arranged around the inner layer;
wherein the inner layer has at least seven second element wires which have the same diameter as that of the center element wire or are smaller than the diameter thereof,
wherein the second element wires of the inner layer are respectively contacted with the center element wire, and the adjacent second element wires of the inner layer are contacted to each other.

2. The stranded electrical insulated wire conductor as claimed in claim 1, wherein in the outer layer second element wires which are the same number of the second element wires of the inner layer are arranged in contact with the adjacent two second element wires of the inner layer, respectively.

3. The stranded electrical insulated wire conductor as claimed in claim 2, wherein a third element wire which is contacted with a circle circumscribed to all the second element wires of the inner layer and a circle circumscribed to all the second element wires of the outer layer is arranged between the adjacent two second element wires of the outer layer.

4. The stranded electrical insulated wire conductor as claimed in claim 1, wherein the element wires of the inner layer and the element wires of the outer layer are twisted in the same direction.

5. The stranded electrical insulated wire conductor as claimed in claim 1, wherein both the second element wires and the third element wires are smaller than the center element wire.

6. The stranded electrical insulated wire conductor as claimed in claim 1, wherein both the number of the second element wires of the outer layer and the number of the third element wires of the outer layer are equal to the number of the second element wires of the inner layer.

7. The stranded electrical insulated wire conductor as claimed in claim 1, wherein the sum of the cross-sectional areas of the second element wires arranged in the outer layer and the third element wires arranged in the outer layer is equal to or greater than 50% of the total cross-sectional area of the stranded wire conductor for the electrical insulated wire.

8. The stranded electrical insulated wire conductor as claimed in claim 4, wherein both the second element wires and the third element wires are smaller than the center element wire.

9. The stranded electrical insulated wire conductor as claimed in claim 4, wherein both the number of the second element wires of the outer layer and the number of the third element wires of the outer layer are equal to the number of the second element wires of the inner layer.

10. The stranded electrical insulated wire conductor as claimed in claim 5, wherein both the number of the second element wires of the outer layer and the number of the third element wires of the outer layer are equal to the number of the second element wires of the inner layer.

11. The stranded electrical insulated wire conductor as claimed in claim 4, wherein the sum of the cross-sectional areas of the second element wires arranged in the outer layer and the third element wires arranged in the outer layer is equal to or greater than 50% of the total cross-sectional area of the stranded wire conductor for the electrical insulated wire.

12. The stranded electrical insulated wire conductor as claimed in claim 5, wherein the sum of the cross-sectional areas of the second element wires arranged in the outer layer and the third element wires arranged in the outer layer is equal to or greater than 50% of the total cross-sectional area of the stranded wire conductor for the electrical insulated wire.

13. The stranded electrical insulated wire conductor as claimed in claim 6, wherein the sum of the cross-sectional areas of the second element wires arranged in the outer layer and the third element wires arranged in the outer layer is equal to or greater than 50% of the total cross-sectional area of the stranded wire conductor for the electrical insulated wire.

14. The stranded electrical insulated wire conductor as claimed in claim 2, wherein the element wires of the inner layer and the element wires of the outer layer are twisted in the same direction.

15. The stranded electrical insulated wire conductor as claimed in claim 3, wherein the element wires of the inner layer and the element wires of the outer layer are twisted in the same direction.

16. The stranded electrical insulated wire conductor as claimed in claim 2, wherein both the second element wires and the third element wires are smaller than the center element wire.

17. The stranded electrical insulated wire conductor as claimed in claim 3, wherein both the second element wires and the third element wires are smaller than the center element wire.

18. The stranded electrical insulated wire conductor as claimed in claim 2, wherein both the number of the second element wires of the outer layer and the number of the third element wires of the outer layer are equal to the number of the second element wires of the inner layer.

19. The stranded electrical insulated wire conductor as claimed in claim 3, wherein both the number of the second element wires of the outer layer and the number of the third element wires of the outer layer are equal to the number of the second element wires of the inner layer.

20. The stranded electrical insulated wire conductor as claimed in claim 2, wherein the sum of the cross-sectional areas of the second element wires arranged in the outer layer and the third element wires arranged in the outer layer is equal to or greater than 50% of the total cross-sectional area of the stranded wire conductor for the electrical insulated wire.
